(19) United States
(12) Patent Application Publication
(10) Pub. No.: US 2026/0287890 A1
(43) Pub. Date: Sep. 24, 2026

(54) Projector-Based HUD With a High Dynamic Range for a Vehicle

(71) Applicant: Bayerische Motoren Werke Aktiengesellschaft, Muenchen (DE)

(72) Inventors: Michael Arthur JANZER, Unterschleissheim (DE); Jasper STERN, Muenchen (DE)

(21) Appl. No.: 19/474,220

(22) PCT Filed: May 27, 2024
(86) PCT No.: PCT/DE2024/100482

§ 371 Date: Oct. 10, 2025

(30) Foreign Application Priority Data
Jun. 1, 2023 (DE) 10 2023 114 430.8

(51) Int. Cl. G02B 27/01; B60K 35/234

(52) U.S. Cl. CPC G02B 27/0101; B60K 35/234; B60K 2360/334; G02B 2027/0118

(57) ABSTRACT

A projection unit for a head-up display device includes a projector-based imager with a projector for generating a light-ray bundle with a desired display content and a projection screen illuminated thereby, wherein the projector is designed to generate an actual image on the projection screen and the projection screen is configured to cast the resultant light-ray bundle onto the vehicle window; and an absorber or light-distribution device which is arranged inside or outside the projector and is configured to impart on the light-ray bundle a light intensity that varies along its ray cross section such that a brightness of the virtual image in a black print region does not exceed a predetermined first brightness value and, in a transparent surface region, does not drop below a predetermined second brightness value, which is at least twice as bright as the first brightness value.

### BACKGROUND AND SUMMARY

The invention relates to a projection unit for a head-up display device which is usable in a motor vehicle or some other land vehicle, aircraft or watercraft and is also known by the designation head-up display (HUD). Such devices serve to generate a virtual image inserted into the field of view of a vehicle occupant by way of reflection at a reflection sheet such as a windshield, rear window or side window of the vehicle. The invention is also directed to the head-up display device and to a vehicle equipped therewith.

In a motor vehicle, for example, a head-up display can present speed indications and other useful navigation, warning and vehicle operation indications or entertainment contents to the driver and/or another occupant in the form of a virtual image when the windshield is viewed. In this case, inter alia, in order to generate a panoramic virtual representation, a simplified HUD design with an image generator is known, the latter being positioned in a window base region of the windshield such that the real image generated by it is reflected directly at the windshield, without any further imaging or deflection optical unit being situated in between.

Previous approaches for technologically realizing such head-up displays generally use liquid crystal displays (LCDs) with a matrix backlight. However, this technology encounters its limits with regard to thermal management and power consumption if the virtual image is intended to be presented in the windshield's transparent region situated above the windshield's lower black-print region provided with a dark or black tinting or coating. Compared with a virtual image that is presented entirely in the black-print region of the windshield, this entails a tenfold increase in the required image brightness in order to ensure a required visibility of the HUD image even under sunny ambient conditions. In order to achieve such high image brightnesses, cost-intensive micro-LED displays could be used, for example. A less costly alternative would be a projector-based image generator in which a projection screen is used instead of the light-emitting display surface, a real image being generated on the projection screen by way of a projector.

In the future, the display surfaces of such HUDs are intended to be able to cover both the black-print region and, situated thereabove, the transparent region of the windshield. This necessitates a great variation of the brightness over the image height: in the black-print region, maximum brightnesses of 1000-3000 cd/m² in the virtual image should not be exceeded, in order to prevent the risk of the driver being dazzled, but at the same time brightnesses of more than 10,000 cd/m² should be attained in the transparent region.

An LCD-based image generator with a matrix backlight could present these locally different brightness requirements quite easily by dimming the corresponding LEDs using pulse width modulation. In the case of a projector-based image generator, this option is omitted since an image generating surface inside the projector is always homogeneously illuminated in conventional projector systems. All that remains currently as a solution for these systems is a local reduction of the brightnesses by omitting the brightest grayscale levels of the image generator. This is not optimal, however, since it reduces the usable grayscale dynamic range in the “darkened” portion of the image and the image would thus have losses of quality in this portion. By way of example, 255 grayscale levels per color would then be available in the bright image portion, but only 200 grayscale levels in the darkened image portion.

It is an object of the present invention to specify an alternative and/or improved projection unit for a head-up display device for use in a vehicle which can be suitable in particular for a large-area and/or panoramic virtual image representation by way of reflection at a windshield. This projection unit and head-up display device can make possible an improvement vis-à-vis known devices for example with regard to their energy efficiency, costs, image quality, visibility of the virtual image and/or other aspects.

This object is achieved by a projection unit and also by a head-up display device containing this projection unit and a vehicle equipped therewith according to the independent claims. Further configurations are specified in the dependent claims. All further-reaching features and effects mentioned for the projection unit in the claims and the following description are also applicable with regard to the head-up display device and the vehicle, and vice versa.

In accordance with a first aspect, a projection unit for a head-up display device for use in a vehicle is provided. The vehicle can be a motor vehicle, but also any other land vehicle, aircraft or watercraft. The head-up display device is designed to insert a virtual image by way of reflection at a vehicle window both in the black or dark printed or tinted black-print region thereof and in the adjacent substantially transparent surface region thereof. It can be embodied as a head-up display (HUD), for example.

The projection unit is designed to output a suitable light beam during operation of the head-up display device and to project it onto the vehicle window such that it is reflected from the latter to the eyes or an eyebox-provided therefor-of at least one vehicle occupant and a virtual image is presented to them as a result. Eyebox of the head-up display device is understood to mean, as usual, a spatial region from which the virtual image is visible without restriction.

For this purpose, the projection unit comprises a projector-based image generator with a projector designed to generate a light beam with desired display content, and with a projection screen illuminated thereby. The projection screen can be illuminated by the projector in reflection or, in an alternative configuration, in transmission. In this case, the projector is designed to generate a real image on the projection screen. The projection screen is designed to project the resultant light beam with a predetermined shape and direction onto the reflection sheet in order to generate a virtual image with desired representation properties for the respective occupant.

Furthermore, the projection unit comprises an absorber or light distribution device arranged inside or outside the projector. This device is designed to impose on the light beam a light intensity that varies along the beam cross-section thereof in such a way that a brightness of the virtual image in the black-print region of the vehicle window does not exceed a predetermined first brightness value and, in the transparent surface region of the vehicle window, does not fall below a predetermined second brightness value, wherein the second brightness value is at least double the magnitude of the first brightness value. In this case, it can be assumed herein, for example, albeit not restrictively, that the vehicle window, in its black-print region and in its transparent surface region, has identical reflection properties for the light beam incident from the projection unit, and the aforementioned different brightness values in the virtual image therefore arise principally as a result of the absorber or light distribution device.

One concept of this projection unit thus consists in the problem-mentioned in the introduction-of greatly different image brightness requirements in the black-print region and in the transparent region of the windshield being solved by way of an adapted light distribution by way of an absorber or light distribution device designed for this purpose in the illumination optical unit. As a result, an unavoidable reduction of the grayscale dynamic range in the black-print region of the windshield in the case of conventional projector-based image generators is prevented and hence a high-quality virtual image display is made possible there as well.

In particular, the second brightness value can be approximately three to ten times the magnitude of the first brightness value. In this regard, for example, the first brightness value can be in a range of approximately 1000 to approximately 3000 cd/m² and the second brightness value can be at least approximately 10,000 cd/m².

In accordance with one embodiment, the absorber or light distribution device is embodied as a transparent plate with a transmission coefficient that varies along the beam cross-section in order to attain the aforementioned effect. In particular, the transparent plate can be embodied with a corresponding absorption gradient for this purpose, such that the device is purely an absorber device.

By way of example, the projector can comprise a light source with a suitable illumination optical unit for generating a homogeneous, collimated illumination beam and also an image generating surface (for example in the form of an LCOS, Liquid Crystal on Silicon, or DMD, Digital Micromirror Device) illuminated thereby, the respective display content being generated on the image generating surface. In the case of the embodiment above, the transparent plate can be arranged for example inside the projector in the beam path of the illumination beam between the illumination optical unit and the image generating surface, ideally directly on or upstream of the image generating surface for reasons of space and/or precision. Alternatively, however, the transparent plate can also be arranged elsewhere in the projector, for example between the image generating surface and a light exit opening in a projector housing, or can optionally be integrated in a transparent projector cover sheet that closes the light exit opening.

Once again as an alternative thereto, the transparent plate in the projection unit can also be arranged outside the projector, i.e. in the beam path of the light beam between the projector and the projection screen or downstream of the projection screen. In this case, in particular, a conventional projector can be used. In a specific configuration in which the entire projection unit is at least partly surrounded by a protective housing with a light exit opening for the light beam to be output, the transparent plate for example can form or be integrated in a cover sheet that mechanically closes this light exit opening.

In accordance with a further embodiment, the absorber or light distribution device is embodied as a light distribution device in which light is not absorbed but rather only redistributed. In this case, too, the projector for generating the light beam has inter alia a light source and an illumination and imaging optical unit with one or more lenses. In this case, the aforementioned light distribution device is formed by at least one of these lenses, for example a cylindrical lens, by virtue of the lens(es) being oriented obliquely with respect to the beam propagation direction of the light beam, or of the above illumination beam, in such a way that an inhomogeneous light distribution caused thereby in the beam cross-section (as a result of an imaging aberration known as coma) produces the aforementioned variation of the light intensity.

In accordance with a further aspect, a head-up display device is provided which is designed for use (i.e. installation) in a vehicle. Besides the projection unit presented herein, it also comprises a reflection sheet that is arranged in the beam path of the light beam output by the projection unit and is in the form of a vehicle window, having a black or dark printed or tinted black-print region and a substantially transparent surface region adjacent thereto. In this case, the reflection sheet is arranged and embodied in the field of view of at least one vehicle occupant in such a way that it reflects the light beam to their eyebox, as a result of which the display content is presentable to them in the form of a virtual image and is actually presented during operation of the head-up display device.

In accordance with one embodiment, the reflection sheet is arranged directly opposite the projection screen, with the exception of possible covers of the projection unit (for example in the form of a cover sheet that allows the light beam to pass) which do not have any beam-shaping, beam-deflecting or imaging optical effect on the light beam. In other words, in this specific embodiment, the head-up display device does not comprise any further optical elements such as deflection or concave mirrors or lenses, etc., in the beam path of the light beam between the projection screen and the reflection sheet. Possible coatings of the projection screen or of the reflection sheet with an optical functionality are still possible in this case, however. This embodiment makes it possible to implement in particular a projection unit which is compact in the vertical direction and which is therefore particularly well suited to a large-area and/or panoramic virtual representation.

In accordance with a further aspect, the vehicle mentioned above is provided. The spatial orientation terms used herein, such as “thereabove”, “thereunder”, “lateral”, “horizontal”, “vertical”, etc., mostly relate to the customary vehicle-fixed Cartesian coordinate system with mutually perpendicular longitudinal, transverse and vertical axes of the vehicle. The vehicle has at least one vehicle window of the type mentioned herein with a black or dark printed or tinted black-print region extending along its window base, for instance a windshield with an instrument panel extending thereunder. The vehicle is equipped with the above head-up display device, the projection unit of which can be installed for example directly in or below a top side of the instrument panel such that the light beam is projected from the projection unit onto the windshield, from which it is reflected to the eyes of a driver and/or of at least one other occupant. However, the projection unit can also be integrated at any other suitable installation location in the vehicle, and it is also possible for other vehicle windows to serve as a reflection sheet.

In particular, in this case, the windshield, at least with a large part of its horizontal extent, can serve as a reflection sheet of the head-up display device. This makes it possible to realize in particular a panoramic virtual representation for the driver and/or passenger.

The above aspects of the invention and the embodiments and specific configurations thereof are explained in greater detail below on the basis of examples illustrated in the accompanying drawings. The drawings should be understood as purely schematic illustrations of the basic optical setup principle, i.e. not as true to scale.

### BRIEF DESCRIPTION OF THE DRAWINGS

FIG. 1 shows a detail from a vehicle with a head-up display device in accordance with one exemplary embodiment of the invention in a vertical longitudinal section, with a schematic illustration of the beam path of the projector light.

FIG. 2 shows a schematic cross-sectional illustration of the optical setup of a projector of the head-up display device from FIG. 1 with an absorber or light distribution device embodied as a transparent plate with an absorption gradient.

FIG. 3 shows a schematic cross-sectional illustration of the optical setup of a projector of the head-up display device from FIG. 1 with an absorber or light distribution device formed by a tilted cylindrical lens of the illumination optical unit.

### DETAILED DESCRIPTION OF THE DRAWINGS

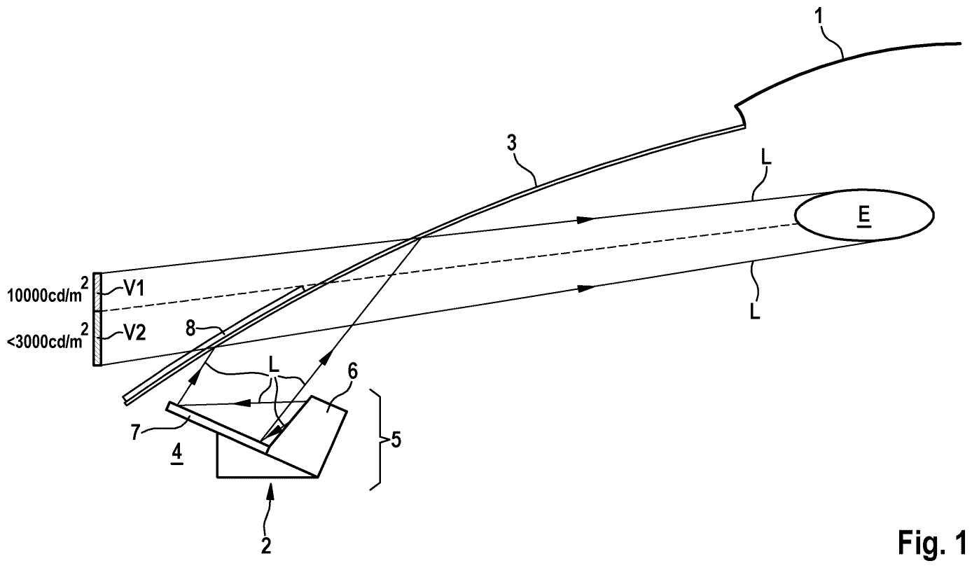

All the various embodiments, alternatives and specific configuration features mentioned further above in the description and in the claims hereinafter for the projection unit, the head-up display device and the vehicle in accordance with the above aspects of the invention can be implemented in the examples shown in FIGS. 1 to 3, in particular also as an alternative or in addition to the features shown therein. Therefore, they are not all repeated again below. The same correspondingly applies to the definitions of terms and effects already specified further above in relation to individual features shown in FIGS. 1-3.

FIG. 1 shows, in a greatly simplified vertical longitudinal sectional illustration, a detail from a vehicle 1 with a head-up display device 2 in accordance with one exemplary embodiment of the invention. The spatial orientation terms used below, such as “horizontal”, “vertical”, “above”, “below”, “thereunder”, etc., relate to the customary vehicle-fixed Cartesian coordinate system with mutually perpendicular longitudinal, transverse and vertical directions of the vehicle 1. In this example, the vehicle 1 is a motor vehicle, indicated merely by its windshield 3 in FIG. 1, the windshield serving as a reflection sheet of the head-up display device 2 as mentioned further above. A projection unit 5 of the head-up display device 2 is arranged thereunder in an instrument panel 4, not illustrated in more specific detail.

The head-up display device 2 is designed to generate a virtual image in image regions V1 and V2 in front of the windshield 3 in the field of view of at least one vehicle occupant, indicated merely by a spatial region (eyebox) E intended for their eyes in the vehicle 1 in FIG. 1. That can involve a driver and/or passenger of the vehicle 1, for example. The head-up display device 2 can be designed in particular for a panoramic virtual representation by virtue of the windshield 3, with almost the entire horizontal extent thereof, serving as a reflection sheet of the head-up display device 2. That is a head-up display (HUD) purely by way of example.

The projection unit 5 contains a projector-based image generator. The latter comprises a projector 6 designed to generate a light beam L with desired display content, and a projection screen 7 illuminated thereby. In this example, the projector 6 is designed to generate a real image on the projection screen 7 in reflection and therefore illuminates the projection screen obliquely from above. In this case, the projection screen 7 is designed to project the resultant, here reflected light beam L with a predetermined shape and direction onto the windshield 3 in order to present to the respective occupant a virtual image with desired representation properties beyond the windshield 3.

The light beam L is indicated by its marginal rays delimiting its beam cross-section required for virtual image generation. A part of the light beam L is reflected from the windshield 3 in the black-print region thereof, which extends along its lower edge and has a black print 8 (merely indicated symbolically in FIG. 1) formed on the windshield 3. Alternatively, in this region the windshield 3 can also be partially or completely darkened by other approaches such as tinting, etc. The remaining part of the light beam L is reflected from a substantially transparent surface region—situated thereabove—of the windshield 3. This necessitates a great variation of the brightness over the image height: in the black-print region, maximum brightnesses of 1000-3000 cd/m² in the corresponding virtual image region V1 should not be exceeded, in order to prevent the risk of the occupants being dazzled. At the same time, however, brightnesses of more than 10,000 cd/m² in the associated virtual image region V2 should be attained in the transparent region.

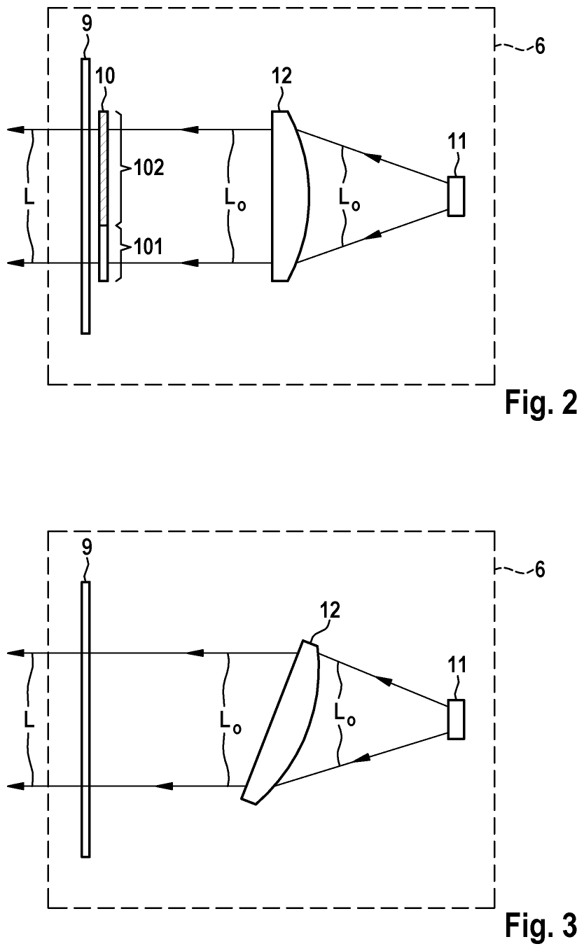

This is achieved in the projection unit 5 presented herein by way of an adapted light distribution in the illumination optical unit, i.e. without needing to reduce a total available grayscale dynamic range of the image generator in the image region V1 by comparison with the image region V2. Some examples of an absorber or light distribution device suitable for this purpose (only illustrated in FIGS. 2 and 3) are explained below.

FIG. 2 shows, in a greatly simplified schematic cross-sectional illustration, a first example of the optical setup of a projector 6 of the head-up display device 2 from FIG. 1. The projector 6 comprises a light source 11, for example in the form of at least one LED, and also a cylindrical converging lens 12 as an illumination optical unit for generating a homogeneous, collimated illumination beam L₀. An image generating surface 9 for example in the form of an LCOS or DMD chip is thereby illuminated in order to generate the respective display content. The resultant light beam L output by the projector 6 is merely schematically indicated in a continuation direction of the illumination beam L₀ in FIG. 2. In reality, in this example the light beam L leaves the image generating surface 9 in reflection, rather than in transmission, and is focused onto the projection screen 7 from FIG. 1 by way of a suitable imaging optical unit, which has been omitted in FIG. 2 for illustration reasons.

In this example, an absorber or light distribution device in the form of a transparent plate 10, having a locally varying absorption, is arranged directly upstream of the image generating surface 9 in the beam cross-section of the homogeneous, collimated illumination beam L₀. The absorption gradient of the transparent plate 10 extends only in one dimension: in its lower portion 101 in FIG. 2, this portion ultimately corresponding to that part of the light beam L which is reflected at the transparent region of the windshield 3 (cf. FIG. 1), the absorption is significantly lower than in the portion 102 situated thereabove, this portion corresponding to that part of the light beam L which is reflected in the black-print region of the windshield 3. As a result, as shown in FIG. 1, the maximum achievable image brightness in the black-print region is reduced to the desired value of a maximum of 3000 cd/m² in this example, without the dynamic range of the grayscale levels having to be reduced for this purpose.

FIG. 3 shows, once again in a greatly simplified schematic cross-sectional illustration similar to FIG. 2, another example of the optical setup of the projector 6 of the head-up display device 2 from FIG. 1. In order to avoid repetition, only the differences with respect to FIG. 2 are described below.

Instead of the transparent plate 10, here as well a cylindrical lens 12 is introduced into the beam path of the illumination optical unit, but is not positioned perpendicularly to the optical axis of the projector 6, but rather in a manner inclined with respect thereto, and a coma effect is thus generated in one dimension. This effect causes an inhomogeneous light distribution on the DLP/LCOS chip and hence a brightness variation in the virtual image as illustrated in FIG. 1. In this example, therefore, the inclined cylindrical lens 12 forms the aforementioned absorber or light distribution device. The embodiment thereof in accordance with FIG. 3 has the advantage over FIG. 2 that light is not absorbed, but rather only distributed differently, by the absorber or light distribution device.

### LIST OF REFERENCE SIGNS

1 vehicle
2 head-up display device
3 windshield
4 instrument panel
5 projection unit
6 projector
7 projection screen
8 black print
9 projector-internal image generating surface
10 transparent plate with absorption gradient
101 lower portion of the transparent plate with low absorption
102 upper portion of the transparent plate with high absorption
11 light source
12 cylindrical converging lens, cylindrical lens
L light beam with display content, also called projector light
L₀ illumination beam for illuminating the projector-internal image generating surface
E eyebox
V1 virtual image region in the black-print region of the windshield
V2 virtual image region in the transparent region of the windshield

1.-10. (canceled)

11. A projection unit for a head-up display device which is configured to insert a virtual image by way of reflection at a vehicle window both in a black or dark printed or tinted black-print region of the vehicle window and in an adjacent substantially transparent surface region of the vehicle window, the projection unit comprising:
a projector-based image generator with a projector for generating a light beam with desired display content and a projection screen illuminated by the projector, wherein the projector is configured to generate a real image on the projection screen and the projection screen is configured to project the resultant light beam with a predetermined shape and direction onto the vehicle window; and
an absorber or light distribution device arranged inside or outside the projector and configured to impose on the light beam a light intensity that varies along a beam cross-section thereof such that, consequently, a brightness of the virtual image in the black-print region of the vehicle window does not exceed a predetermined first brightness value and, in the transparent surface region of the vehicle window, does not fall below a predetermined second brightness value, which is at least double a magnitude of the first brightness value.

12. The projection unit according to claim 11, wherein:
the second brightness value is approximately three to ten times the magnitude of the first brightness value; or
the first brightness value is in a range of approximately 1000 to approximately 3000 cd/m² and the second brightness value is at least approximately 10,000 cd/m².

13. The projection unit according to claim 11, wherein:
the absorber or light distribution device is embodied as a transparent plate with a transmission coefficient that varies along the beam cross-section of the light beam or along a beam cross-section of an illumination beam serving to generate the display content.

14. The projection unit according to claim 13, wherein:
the transparent plate is embodied with a corresponding absorption gradient.

15. The projection unit according to claim 13, wherein:
the projector has a light source and an illumination optical unit for generating the illumination beam and an image generating surface illuminated by the illumination optical unit and serving to generate the display content; and
the transparent plate is arranged inside the projector in a beam path of the illumination beam between the illumination optical unit and the image generating surface.

16. The projection unit according to claim 15, wherein the transparent plate is arranged directly on or upstream of the image generating surface.

17. The projection unit according to claim 13, wherein:
the transparent plate is arranged outside the projector in the beam path of the light beam between the projector and the projection screen or downstream of the projection screen.

18. The projection unit according to claim 17, wherein:
the projection unit is at least partly surrounded by a protective housing with a light exit opening for the light beam to be output, and the transparent plate forms or is integrated in a cover sheet that mechanically closes the light exit opening.

19. The projection unit according to claim 11, wherein:
the projector for generating the light beam has a light source and an illumination and imaging optical unit with one or more lenses; and
the absorber or light distribution device is a light distribution device which is formed by at least one of the lenses, which is oriented obliquely with respect to a beam propagation direction of the light beam, or of an illumination beam serving to generate the display content, such that an inhomogeneous light distribution caused thereby in the beam cross-section of the beam produces variation of the light intensity.

20. A head-up display device for a vehicle, the head-up display device comprising:
the projection unit according to claim 11; and
a reflection sheet that is to be arranged in the beam path of the light beam output by the projection unit and is in a form of the vehicle window;
wherein the reflection sheet is arranged and embodied in a field of view of at least one vehicle occupant such that the reflection sheet reflects the light beam to an eyebox predetermined for eyes of the at least one vehicle occupant, as a result of which the display content is presentable to the at least one vehicle occupant in a form of a virtual image beyond the reflection sheet.

21. The projection unit according to claim 20, wherein:
the reflection sheet is arranged directly opposite the projection screen, with the exception of covers of the projection unit which do not have any beam-shaping, beam-deflecting or imaging optical effect on the light beam.

22. A vehicle with mutually perpendicular longitudinal, transverse and vertical directions of a vehicle-fixed Cartesian coordinate system, the vehicle comprising:
the vehicle window with the black or dark printed or tinted black-print region extending along its lower edge, and with the substantially transparent surface region situated above the black-print region; and
the head-up display device according to claim 20, the reflection sheet of which is formed by the vehicle window,
wherein at least one part of the black-print region and of the transparent surface region serves as a reflection sheet.

23. The projection unit according to claim 22, wherein the vehicle is a motor vehicle.

24. The projection unit according to claim 22, wherein the vehicle window is a windshield.

25. The vehicle according to claim 24, wherein:
the vehicle has an instrument panel arranged below the windshield; and
the projection unit and the projection screen are arranged in or under a top side of the instrument panel such that the windshield, at least with a large part of its horizontal extent, serves as a reflection sheet of the head-up display device.
